(19) United States
(12) Patent Application Publication
(10) Pub. No.: US 2021/0249872 A1
(43) Pub. Date: Aug. 12, 2021

(54) BATTERY SYSTEM

(71) Applicant: SAMSUNG SDI CO., LTD., Yongin-si (KR)

(72) Inventors: Jürgen FRITZ, Graz (AT); Markus PRETSCHUH, Graz (AT)

(21) Appl. No.: 17/165,044

(22) Filed: Feb. 2, 2021

(30) Foreign Application Priority Data
Feb. 6, 2020 (EP) 20155828.5
Jan. 26, 2021 (KR) 10-2021-0010931

(51) Int. Cl. H02J 7/00; H02M 3/04

(52) U.S. Cl. CPC H02J 7/0013; H02M 3/04

(57) ABSTRACT

A battery system includes a stack of battery cells connected between first and second stack nodes, the stack to supply a stack voltage to a first battery system output node connected to the first stack node; a DC/DC converter to receive a first output voltage of the stack, and to down-convert the first output voltage to a second output voltage; a battery actuator interconnected between the stack and one of the first battery system output node and a second battery system output node, and controlled to be set either conductive or non-conductive; and a controller to control the battery actuator, the controller including a first input node receiving the second output voltage and a second input node connected to the second stack node, the controller to output a first switch signal via a first controller output node and a second switch signal via a second controller output node.

### CROSS-REFERENCE TO RELATED APPLICATIONS

European Patent Application No. 20155828.5, filed on Feb. 6, 2020, in the European Patent Office and entitled: “Battery System,” and Korean Patent Application No. 102021-0010931, filed on Jan. 26, 2021, in the Korean Intellectual Property Office, and entitled: “Battery System,” are incorporated by reference herein in their entirety.

### BACKGROUND

### 1. Field

Embodiments relate to a battery system and a controller for such a battery system.

### 2. Description of the Related Art

A rechargeable or secondary battery differs from a primary battery in that it may be repeatedly charged and discharged, while the latter provides only an irreversible conversion of chemical to electrical energy. Low-capacity rechargeable batteries are used as power supply for small electronic devices, such as cellular phones, notebook computers and camcorders, while high-capacity rechargeable batteries are used as the power supply for hybrid vehicles and the like.

In general, rechargeable batteries include an electrode assembly including a positive electrode, a negative electrode, and a separator interposed between the positive and negative electrodes, a case receiving the electrode assembly, and an electrode terminal electrically connected to the electrode assembly. An electrolyte solution is injected into the case in order to enable charging and discharging of the battery via an electrochemical reaction of the positive electrode, the negative electrode, and the electrolyte solution. The shape of the case, e.g., cylindrical or rectangular, depends on the battery's intended purpose.

Rechargeable batteries may be used as a battery module formed of a plurality of unit battery cells coupled in series and/or in parallel so as to provide a high energy density. That is, the battery module is formed by interconnecting the electrode terminals of the plurality of battery cells depending on a required amount of power and in order to realize a high-power rechargeable battery. In general, one or more battery modules are mechanically and electrically integrated, equipped with a thermal management system and set up for communication with one or more electrical consumers in order to form a battery system.

For meeting the dynamic power demands of various electrical consumers connected to the battery system a static control of battery power output and charging may be replaced by a steady or intermittent exchange of information between the battery system and the controllers of the electrical consumers. This information includes the battery systems actual state of charge (SoC), potential electrical performance, charging ability and internal resistance as well as actual or predicted power demands or surpluses of the consumers.

For monitoring, controlling, and/or setting of the aforementioned information, a battery system usually includes a battery management system, BMS. Such a control unit may be integral with the battery system, or may be part of a remote controller communicating with the battery system via a suitable communication bus. In both cases, the control unit communicates with the electrical consumers via a suitable communication bus, e.g., a CAN or SPI interface.

### SUMMARY

Embodiments are directed to a battery system, including: a battery cell stack including battery cells connected between a first stack node and a second stack node, the battery cell stack being configured to supply a stack voltage to a first battery system output node that is connected to the first stack node; a DC/DC converter configured to receive a first output voltage of the battery cell stack, and to down-convert the first output voltage to a second output voltage; a battery actuator interconnected between the battery cell stack and one of the first battery system output node and a second battery system output node, and configured to be controlled to be set either conductive or non-conductive; and a controller configured to control the battery actuator, the controller including a first input node receiving the second output voltage and a second input node connected to the second stack node, the controller being configured to output, to the battery actuator, a first switch signal via a first controller output node and a second switch signal via a second controller output node.

The battery system may further include a low voltage battery that is charged by the second output voltage.

The first output voltage may be supplied by less than all of the battery cells of the battery cell stack.

The DC/DC converter may be one of a buck converter, a buck-boost-converter, a low-dropout regulator, a flyback converter, a forward converter, and a push-pull-converter.

The DC/DC converter may include: a first switch and an inductance connected in series between a converter input node and a converter output node, a converter node in between the first switch and the inductance, and a second switch connected between the second stack node and the converter node.

Embodiments are also directed to a battery system, including: a battery cell stack including battery cells connected between a first stack node and a second stack node, and configured to supply a stack voltage to a first battery system output node that is connected to the first stack node; a low voltage battery configured to supply a battery voltage; a galvanically isolated DC/DC converter configured to receive the battery voltage, and to convert the battery voltage to a second output voltage; a battery actuator interconnected between the battery cell stack and one of the first battery system output node and a second battery system output node, and configured to be controlled to be set either conductive or non-conductive; and a controller configured to control the battery actuator, the controller including a first input node receiving the second output voltage, and a second input node connected to the second stack node, wherein the controller is configured to output, to the battery actuator, a first switch signal via a first controller output node and a second switch signal via a second controller output node.

The first switch signal may be at a same voltage level as the second output voltage, and/or the second switch signal may be at a same voltage level as the second stack node.

The controller may include: a high side driver interconnected between the first input node and the first controller output node, and a low side driver interconnected between the second input node and the second controller output node.

The second stack node may be at a ground voltage potential of the battery system.

The battery actuator may be a first battery actuator, and may be interconnected between the first stack node and the first battery system output node; and the battery system may further include a second battery actuator interconnected between the second stack node and the second battery system output node. Each of the first battery actuator and the second battery actuator may be connected to the first controller output node and to the second controller output node.

The battery system may further include a precharge battery actuator connected in series with a precharge resistor. The precharge battery actuator and the precharge resistor may be commonly connected in parallel to the second battery actuator, and the precharge battery actuator may be connected to the first controller output node and to the second controller output node.

The high side driver may include a plurality of high side switches, each of the high side switches being interconnected between the first input node and one of a plurality of battery actuators, and the low side driver may include a plurality of low side switches, each of the low side switches being interconnected between the second input node and one of the plurality of battery actuators.

The battery system may further include a switch control circuit configured to individually control a conductivity state of each of the high side switches and each of the low side switches.

The battery actuator may be one of a contactor and a relay.

Embodiments are also directed to a battery system controller, including: a DC/DC converter configured to receive a first output voltage of a battery cell stack, and to down-convert the first output voltage to a second output voltage; and a battery actuator controller that includes a first input node that receives the second output voltage, and a second input node that is connected to a second stack node of the battery cell stack. The battery actuator controller may be configured control a battery actuator and to output, to the battery actuator, a first switch signal via a first controller output node and a second switch signal via a second controller output node.

### BRIEF DESCRIPTION OF THE DRAWINGS

Features will become apparent to those of ordinary skill in the art by describing in detail example embodiments with reference to the attached drawings in which:

FIG. 1 illustrates a schematic circuit diagram of a battery system according to an example embodiment;

FIG. 2 illustrates a schematic circuit diagram of a battery system according to another example embodiment;

FIG. 3 illustrates a schematic circuit diagram of a battery system according to another example embodiment;

FIG. 4 illustrates a schematic circuit diagram of a battery system according to another example embodiment;

FIG. 5 illustrates a schematic circuit diagram of a battery system according to another example embodiment; and

FIG. 6 illustrates a timing diagram of the battery system as shown in FIG. 4.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. In the drawing figures, the dimensions of layers and regions may be exaggerated for clarity of illustration. Like reference numerals refer to like elements throughout.

As used herein, the term “and/or” includes any and all combinations of one or more of the associated listed items. It will be understood that if the terms “first” and “second” are used to describe elements, these elements are limited by these terms. These terms are only used to distinguish one element from another element. For example, a first element may be named a second element and, similarly, a second element may be named a first element. Expressions such as “at least one of,” when preceding a list of elements, modify the entire list of elements and do not modify the individual elements thereof.

As used herein, the term “substantially,” “about,” and similar terms are used as terms of approximation and not as terms of degree, and are intended to account for deviations in measured or calculated values that would be recognized by those of skill in the art. If the term “substantially” is used in combination with a feature that could be expressed using a numeric value, the term denotes a range of +/−5% of the value centered on the value.

According to a first example embodiment, a battery system is provided, e.g., a high voltage battery system for an electric vehicle (EV) or plug-in hybrid electric vehicle (PHEV). The battery system of the present example embodiment includes a battery cell stack that is formed of a plurality of battery cells that are connected in series and/or in parallel between a first stack node and a second stack node of the battery cell stack. The battery cells may be lithium ion battery cells and further preferred are prismatic battery cells. However, the battery cells may also be pouch type battery cells and/or battery cells of other chemistry. The battery cell stack may be configured to supply a stack voltage, e.g., a high voltage of at least 48 V, e.g., a high voltage of 100 V or more, to a first output node of the battery system. In an example embodiment, the stack voltage is applied between a first output node and a second output node of the battery system, wherein the second output node may be at ground potential. The first output node of the battery system is connected to the first stack node and the second output node of the battery system may be connected to the second stack node.

The battery system of the present example embodiment further includes a DC/DC converter that may be configured to receive a first output voltage of the battery cell stack, and to down-convert the received first output voltage to a second output voltage. The first output voltage is a voltage that may be equal to or less than the stack voltage of the battery cell stack. Thus, the DC/DC converter receives a voltage output of some or all of the stacked battery cells. In an example embodiment, the DC/DC converter is connected between the first stack node and the second stack node. However, other ways of connecting the DC/DC converter to the stack are possible.

The battery system of the present example embodiment further includes a battery actuator that is interconnected between the battery cell stack and one of the first output node and the second output node. The battery actuator is a component that may be configured to be controlled to be either conductive or non-conductive. Thus, the battery actuator may be set to be either conductive or non-conductive with respect to an output voltage of the battery system, e.g., the stack voltage. The battery actuator may thus be used to separate the battery cell stack from a load connected thereto by cutting or interrupting a conducting connection between the stack and an output node.

The battery system of the present example embodiment further includes a controller that includes a first input node for receiving the second output voltage, i.e., the down-converted voltage as output by the DC/DC converter. The controller further includes a second input node that is connected to the second stack node and at the ground potential of the battery stack of the battery system. The controller of the battery system may be configured to output a first switch signal to the battery actuator via a first output node, and may be configured to output a second switch signal to the battery actuator via a second output node. The controller is further configured to control the battery actuator by the first and second switch signals output thereto. In the context of the present example embodiment, the first and second switch signals may be voltage levels that are applied to a circuit connecting the first and second output node.

In the battery system of the present example embodiment, the battery actuators are advantageously not controlled by a low voltage (LV) circuitry that is power supplied by a low voltage battery. That is, any noise on the high voltage side of the battery system cannot couple to the low voltage side via the battery actuators. In the battery system of the present example embodiment, the controller may be completely independent from a voltage level of any low voltage battery. In an example embodiment, a ground potential applied to the controller is not a ground potential of an electric vehicle (such as the potential of a chassis of the electric vehicle) but is a ground potential of the high voltage battery system (which may be above the ground potential of the electric vehicle as a whole and any low voltage battery system thereof). Thus, the voltage level at the second stack node may be different from the voltage level of the low voltage ground (chassis). Thus, the second stack node potential may define a ground voltage of battery system.

The battery system of the present example embodiment may help to prevent malfunctions of the battery actuators due to voltage shortage, e.g., during a cold cranking event or the like. Further, coupling between the high voltage side of the battery system, i.e., from the conducting lines controlled by the battery actuator, to the control circuitry of the battery actuator may be prevented so as not to interfere with the low voltage ground potential of the electric vehicle as a whole. Usually, coupling constants between the high voltage side of a battery system and the low voltage ground of an electric vehicle are high, whereas the present example embodiment connects the controller to the low voltage ground of the battery system via the DC/DC converter, such that these coupling constants are prevented from applying to the battery actuators of the present example embodiment. Hence, coupling of AC perturbations into the low voltage domain of an electric vehicle may be advantageously decreased. In an example embodiment, a converter with galvanic isolation is used in the battery system to decrease coupling of AC perturbations.

In an example embodiment, the battery system further includes a low voltage battery that is charged by the second output voltage. Such a low voltage battery is often disposed in electric or plug-in hybrid vehicles for power supplying security relevant functions of the electric vehicle, such as power steering, ABS, or the like. By charging the low voltage battery by the second output voltage, the DC/DC converter of the battery system is advantageously put to an additional use and hence redundancy in the battery system may be reduced. The output of the DC/DC converter supplying the low voltage battery may be isolated from the output of the DC/DC converter supplying the second output voltage to the controller. In an example embodiment, the low voltage battery is a 12 V battery. In such case the second output voltage is about 12 V. In an example embodiment, the stack voltage of the battery system is about 60 V, about 100 V or about 400 V.

In another example embodiment, the first output voltage is supplied to the DC/DC converter by a fraction, e.g., less than all, of the stacked battery cells. In such a case, the DC/DC converter is not interconnected between the first stack node and the second stack node, but is rather connected between the second stack node and an intermediate node of the cell stack. The intermediate node divides the battery cell stack such that the fraction of battery cells supplying the DC/DC converter is interconnected between the intermediate node and the second stack node. According to this example embodiment, the first output voltage is below the stack voltage of the battery cell stack and hence advantageously the DC/DC converter may be configured for a smaller degree of down-conversion, and may be dimensioned smaller and be lighter. This is advantageous for any mobile application in any kind of electric vehicle.

In an example embodiment, the DC/DC converter used in the battery system is one of a buck converter, a buck-boost-converter, a low-dropout regulator, a flyback converter, a forward converter, and a push-pull-converter. In the battery system of the present example embodiment, a DC/DC converter providing galvanic isolation, such as e.g., a forward converter, a flyback converter, or a push-pull-converter, is used in order to further decouple the HV domain from any LV domain of the battery system, e.g., when the DC/DC converter is also used for charging a LV battery.

In an example embodiment, the DC/DC converter includes a first switch and an inductance, which are interconnected in series between a converter input node (the first stack node) and a converter output node. The DC/DC converter may further include a converter node that is disposed in between the first switch and the inductance, as well as a second switch that is connected between the second stack node and the converter node. This design provides a simple DC/DC converter with the desired functionality.

According to a second example embodiment, a battery system is provided that also includes a battery cell stack that is formed of a plurality of battery cells that are connected between a first stack node and a second stack node, and that are configured to supply a stack voltage to a first output node that is connected to the first stack node. The battery system according to this example embodiment further includes a low voltage battery that may be configured to supply a battery voltage. The low voltage battery may be a 12 V battery as usually mounted to vehicles. The battery system according to this example embodiment further includes a galvanically isolated DC/DC converter that may be configured to receive the battery voltage and to convert the received voltage to a second output voltage. The battery system according to this example embodiment further includes a battery actuator that is interconnected between the battery cell stack and one of the first output node and the second output node, and configured to be controlled to be set either conductive or non-conductive, and further includes a controller that has a first input node receiving the second output voltage and that has a second input node connected to the second stack node. The controller may be configured to output, to the battery actuator and for controlling the battery actuator, a first switch signal via a first output node and a second switch signal via a second output node.

According to the second example embodiment, the low voltage domain of the vehicle is decoupled from the high voltage domain of the battery system by the galvanically isolated DC/DC converter. Hence, the battery actuators are still operated by the battery voltage of the low voltage battery, but still the coupling paths between the high voltage battery system and the low voltage domain (which usually has high coupling constants) is interrupted. Hence, the present example embodiment provides the same advantageous as described with respect to the first example embodiment, while the battery actuators are still operated by the battery voltage of the low voltage battery. Thus, the DC/DC converter may be configured for galvanically isolating the low voltage battery from the battery actuators. In the following, elements are described that apply equally to the first and second example embodiments.

In an example embodiment of the battery system, the first switch signal and the second switch signal are different voltage levels, i.e., potentials, applied to a circuitry that is connecting the first output node and the second output node of the controller. In an example embodiment, the first switch signal is on the voltage level of the second output voltage, i.e., the stepped-down voltage as output by the DC/DC converter. In an example embodiment, the second switch signal is on the voltage level of the second stack node, i.e., on the ground voltage level of the high voltage battery system. Thus, any influence on a low voltage ground potential via the controller may be avoided in the battery system of the present example embodiment, hence providing, e.g., decreased AC coupling.

In another example embodiment, the controller includes a high side driver that is interconnected between the first input node and the first output node. According to this example embodiment, the controller further includes a low side driver that interconnected between the second input node and the second output node. In an example embodiment, the high side driver and the low side driver are separated sub-circuits of the controller, e.g., they may be separated integrated circuits. In an example embodiment, the high side driver and the low side driver are isolated from each other. In an example embodiment, the high side driver receives solely the second output voltage, and the low side driver receives solely the voltage supplied by the second stack node (HV ground). Thus, the high side driver is isolated from the HV ground, and the low side driver is isolated from the second output voltage supplied by the DC/DC converter. However, the high side driver and the low side driver may also be realized as a single integrated circuit.

In another example embodiment, the battery system includes a first battery actuator that is interconnected between the first stack node and the first output node, and a second battery actuator that is interconnected between the second stack node and the second output node. The first battery actuator and the second battery actuator may be main battery actuators that may be used to safely and reliably disconnect the battery cell stack from any downstream load, e.g., if the battery is malfunctioning. According to this example embodiment, each of the first battery actuator and the second battery actuator is connected to the first output node and to the second output node. In an example embodiment, the first battery actuator and second battery actuator are selectively connected to the first output node and to the second output node. Thus, none, one or both of the first and second battery actuators may be connected to the first and second output node, respectively. In an example embodiment, the first output node and the second output node include subnodes for connecting individually to the first battery actuator and the second battery actuator, respectively.

In an example embodiment, the battery system includes a precharge battery actuator that is connected in series with a precharge resistor and that is connected in parallel to the second battery actuator together with the precharge resistor. Thus, the precharge battery actuator and the precharge resistor are disposed in a precharge conducting path that is connected parallel to the second battery actuator. In this example embodiment, also the precharge battery actuator is connected to the first output node and to the second output node. The connection is either selectively or via subnodes of the first and second output node, as described above with respect to the first and second battery actuator. The precharge battery actuator and the precharge resistor disposed together in the precharge conducting path may allow limiting the current drawn from or charged to the battery system by limiting the current via the precharge resistor, particularly on turn-on. By also controlling the precharge battery actuator via the controller of the battery system of the present example embodiment, the redundancy in the battery system is reduced.

In an example embodiment of the battery system, the high side driver includes a plurality of high side switches, wherein each of the high side switches is interconnected between the first input node and one of a plurality of battery actuators. Thus, each of the high side switches controls the conductivity (current flow) via an individual conducting path connecting the first input node, the respective high side switch, and a respective battery actuator. Thus, the first output node may be considered to include each of these conducting paths as individual subnodes of the first output node. In this example embodiment, the first switch signal is individually applied to each of the battery actuators with a simple circuitry and thus computational controlling effort is reduced.

Further, in this example embodiment, the low side driver includes a plurality of low side switches, wherein each of the low side switches is interconnected between the second input node and one of a plurality of battery actuators. Thus, each of the low side switches controls the conductivity (current flow) via an individual conducting path connecting the second input node, the respective low side switch, and a respective battery actuator. The second output node may thus be considered to include each of these conducting paths as individual subnodes of the second output node. In this example embodiment, also the second switch signal is individually applied to each of the battery actuators with a simple circuitry and thus computational control effort is reduced.

In an example embodiment, the conductivity of each of the high side switches and each of the low side switches is individually controlled by a switch control circuit. Thus, the switch control circuit may be configured to individually control the conductivity of each of the high side switches and each of the low side switches. In an example embodiment, the high side driver includes a first switch control circuit configured to control the conductivity of each of the high side switches individually, and the low side driver includes a second switch control circuit configured to control the conductivity of each of the low side switches individually. In an example embodiment, the high side switches and/or the low side switches are transistor switches, and the high and/or the low side switches may include IGBT or MOSFET transistors.

The battery actuators may be, e.g., a battery contactor or a relay. The battery contactors may be configured to be normally open, i.e., non-conducting, and may be advantageously connected directly to a load. The relays may be configured either normally open or normally closed, and may be easily set up for a variety of applications within the system.

Another example embodiment relates to a battery system controller, for a battery system. The battery system controller includes at least the DC/DC converter and the controller as described above. The battery system controller includes at least a first input node configured to receive the first output voltage of the battery cell stack and a second input node connected to the second stack node. The battery system controller also includes at least one first output node to which the first switch signal applies and at least one second output node to which the second switch signal applies. The battery system controller of the present example embodiment may be part of a battery disconnect unit (BDU) or a battery junction box (BJB).

The electronic or electric devices and/or any other relevant devices or components according to embodiments described herein may be implemented utilizing any suitable hardware, firmware (e.g., an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. The electrical connections or interconnections described herein may be realized by wires or conducting elements, e.g., on a PCB or another kind of circuit carrier. The conducting elements may include metallization, e.g., surface metallizations and/or pins, and/or may include conductive polymers or ceramics. Further electrical energy may be transmitted via wireless connections, e.g., using electromagnetic radiation and/or light.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, e.g., a random access memory (RAM). The computer program instructions may also be stored in other non-transitory computer readable media, e.g., a CD, flash drive, or the like.

Also, a person of skill in the art will recognize that the functionality of various computing devices may be combined or integrated into a single computing device, or the functionality of a particular computing device may be distributed across one or more other computing devices without departing from the scope of the embodiments.

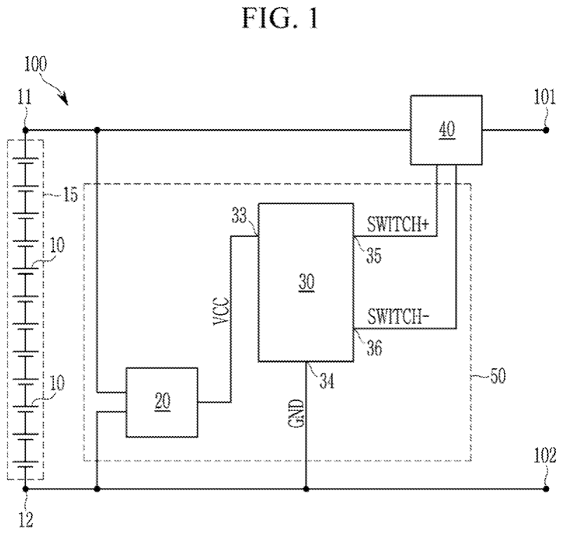

FIG. 1 schematically illustrates a battery system 100 according to an example embodiment.

In the present example embodiment, the battery system 100 includes a plurality of battery cells 10 forming a battery cell stack 15 that is interconnected between a first stack node 11 and a second stack node 12. A stack voltage, e.g., 60 V, applies to the first stack node 11, while the second stack node 12 is at a ground potential GND of the battery system 100. For a battery system 100 disposed in an electric vehicle, this GND differs from a low voltage ground potential, e.g., of a chassis of the electric vehicle. In the battery system 100 of the present example embodiment, the first stack node 11 is connected to a first output node 101 of the battery system 100, and the second stack node 12 is connected to a second output node 102 of the battery system 100. A battery actuator 40 is interconnected between the first stack node 11 and the first output node 101. The battery actuator 40 is a contactor or a relay configured to set a path between the first stack node 11 and the first output node 101 to be either conductive or non-conductive.

The battery system 100 further includes a battery system controller 50 that is connected to the battery stack 15, particularly to each of the first stack node 11 and the second stack node 12. The battery system controller 50 is further connected to the battery actuator 40. In FIG. 1, the battery system controller 50 is illustrated by the dashed line and includes a DC/DC converter 20 and a battery actuator controller 30. The DC/DC converter 20 is connected to the first stack node 11 and to the second stack node 12, and thus receives the stack voltage as a first input voltage. The DC/DC converter 20 may be configured to down-convert the stack voltage to a second output voltage VCC of approximately 12 V. The DC/DC converter 20 outputs the second output voltage, e.g., approximately 12 V, to the battery actuator controller 30 that receives it via a first input node 33. The battery actuator controller 30 further has a second input node 34 that is connected to the second stack node 12 and receives the ground GND of the battery system 100. The battery actuator controller 30 outputs a first switch signal SWITCH+via a first output node 35 and a second switch signal SWITCH− via a second output node 36 to the battery actuator 40.

The first switch signal SWITCH+ or the second switch signal SWITCH− are selectively supplied to a coil of the battery actuator 40 by the battery actuator controller 30, and control a conductivity of the battery actuator 40, i.e., a conduction state of a switch constituting the battery actuator 40. The battery actuator controller 30 outputs the first switch signal SWITCH+ and the second switch signal SWITCH− using the output voltage (the second voltage) of the DC/DC converter and the ground voltage (GND) of the battery system 100. For example, the first switch signal SWITCH+ may have a voltage level of the second voltage, and the second switch signal SWITCH− may have a ground voltage level of the battery system 100. In this case, when the battery actuator controller 30 applies the first switch signal SWITCH+ and the second switch signal SWITCH− to both ends of the coil of the battery actuator 40, a current flows through the coil of the battery actuator 40, so that the battery actuator 40 is set conductive (or non-conductive). Further, when the battery actuator controller 30 cuts off the output of at least one of the first switch signal SWITCH+ and the second switch signal SWITCH−, a current flow through the coil of the battery actuator 40 is cut off, so that the battery actuator 40 is set non-conductive (or conductive).

The battery actuator controller 30 receives only a ground GND of the high voltage battery system 100, i.e., the battery stack 15, but does not receive any ground voltage of a low voltage board net.

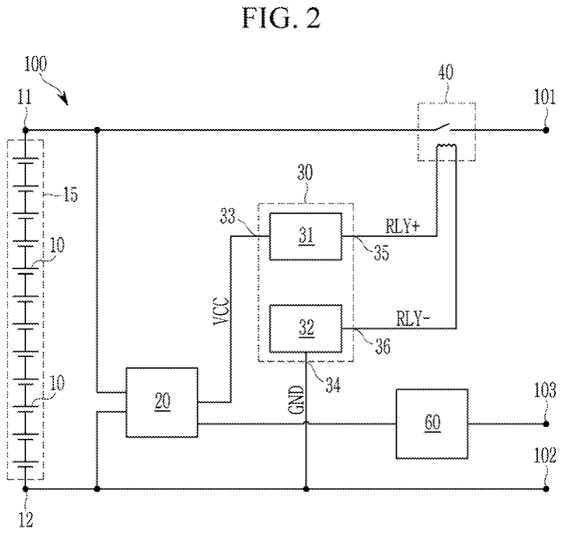

FIG. 2 illustrates a schematic circuit diagram of a battery system 100 according to another example embodiment not including the battery system controller 50 but rather including the DC/DC converter 20 and the battery actuator controller 30 as separate hardware components.

As illustrated in FIG. 2, the battery actuator 40 is a relay that includes a relay switch that is actuated, i.e., either closed (set conducting) or opened (set non-conducting), by a relay coil. As further illustrated in FIG. 2, the battery actuator controller 30 includes a high side driver 31 and a low side driver 32. The high side driver 31 is interconnected between the first input node 33 and the first output node 35, and supplies a first switch signal RLY+ to a first terminal end of the relay coil. The low side driver 32 is interconnected between the second input node 34 and the second output node 36, and supplies a second switch signal RLY− to a second terminal end of the relay coil. The battery actuator controller 30 may be configured to selectively supply either the first switch signal RLY+ or the second switch signal RLY− to the relay coil.

The first switch signal RLY+ may have a voltage level of the output voltage of the DC/DC converter 20 (the second voltage), and the second switch signal RLY− may have a ground voltage level of the battery system 100. When the first switch signal RLY+ and the second switch signal RLY− are supplied to the relay coil, a current flows through the relay coil, and thereby the relay switch of the normally-open relay used as battery actuator 40 is set conductive. When the first switch signal RLY+ or the second switch signal RLY− is not supplied to the relay coil, a current flow through the relay coil is cut off, and thereby the relay switch of the normally-open relay 40 is set non-conductive. The battery system 100 further includes a low voltage battery 60, e.g., a 12 V battery, that is also supplied, i.e., charged by the output voltage of the DC/DC converter 20. The low voltage battery 60 supplies the low voltage of 12 V to a low voltage output node 103.

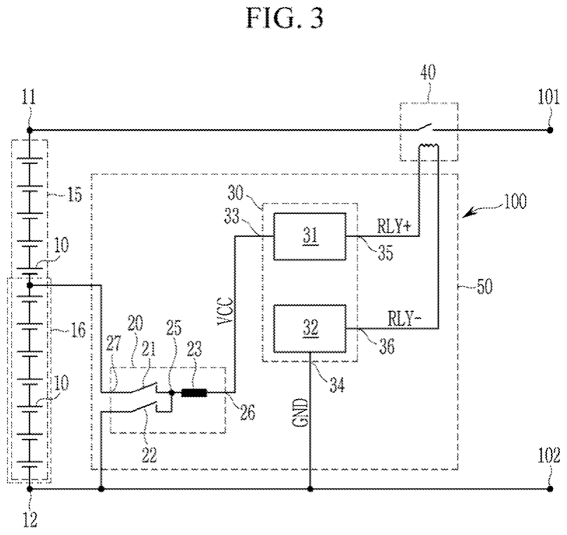

FIG. 3 illustrates a schematic circuit diagram of a battery system 100 according to even another embodiment.

The battery system 100 again includes the battery system controller 50 indicated by the dashed line which is including a circuit carrier board on which the further components, i.e., DC/DC converter 20 and battery actuator controller 30, are surface mounted as integrated components.

In the battery system 100 of FIG. 3, the battery system controller 50 is not connected to the first stack node 11 but receives a first output voltage provided from a fraction 16 of the stacked battery cells 10 such that the first output voltage is below the stack voltage of the battery cell stack 15.

In the present example embodiment, the DC/DC converter 20 is connected to a high side of the fraction 16 of battery cells 10 via a first switching element 21, which is connected in series with an inductance 23 between a converter output node 26 and the battery cell fraction 16. Further, the DC/DC converter 20 includes a converter node 25 that is interconnected between the first switch 21 and the inductance 23, and that is connected to the second stack node 12 via a second switch 22. This allows for a simple implementation of the DC/DC converter 20. The battery actuator controller 30 may be configured as already described with respect to FIG. 2, i.e., with a high side driver 31 and a low side driver 32.

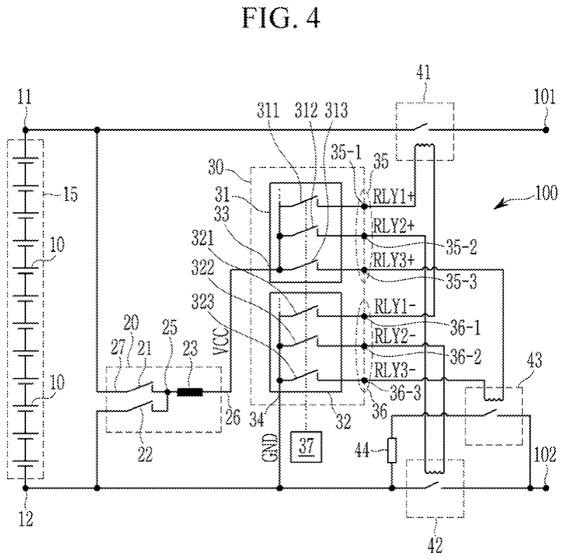

FIG. 4 illustrates a schematic circuit diagram of a battery system 100 according to another example embodiment.

The battery system 100 according to the present example embodiment includes a first battery actuator relay 41 interconnected between the first stack node 11 and the first system output node 101, a second battery actuator relay 42 interconnected between the second stack node 12 and the second system output node 102, and a third battery actuator relay 43 connected in parallel with the second battery actuator relay 42 and connected in series with a precharge resistor 44. According to this example embodiment, the high side driver 31 includes a plurality of high side switches 311, 312, 313, and the low side driver 32 includes a plurality of low side switches 321, 322, 323. Each of these switches 311, 312, 313, 321, 322, 323 may be configured as a transistor switch, i.e., to include at least one transistor. Further, each of these switches 311, 312, 313, 321, 322, 323 may be configured to be individually set conductive or non-conductive by a signal received from a switch control circuit 37 (the dashed-dotted line in FIG. 4). Further, the high side switches 311, 312, 313 may be connected to different relays 41, 42, 43 via different first output node 35 and used to individually control a conductivity of the relays 41, 42, 43, and the low side switches 321, 322, 323 may be connected to different relays 41, 42, 43 via different second output node 36 and used to individually control the conductivity of the relays 41, 42, 43.

In an example embodiment, the first high side switch 311 is interconnected between the first input node 33 and the first output node 35-1 of the battery actuator controller 30, and may be configured to selectively apply the second output voltage VCC as first switch signal RLY1+ to the first battery actuator relay 41. Further, the first low side switch 321 is interconnected between the second input node 34 and the second output node 36-1 of the battery actuator controller 30, and may be configured to selectively apply the potential of the second stack node 12 as second switch signal RLY1− to the first battery actuator relay 41.

Further, the second high side switch 312 is interconnected between the first input node 33 and the first output node 35-2 of the battery actuator controller 30, and may be configured to selectively apply the second output voltage VCC as first switch signal RLY2+ to the second battery actuator relay 42. Further, the second low side switch 322 is interconnected between the second input node 34 and the second output node 36-2 of the battery actuator controller 30, and may be configured to selectively apply the potential of the second stack node 12 as second switch signal RLY2− to the second battery actuator relay 42.

Further, the third high side switch 313 is interconnected between the first input node 33 and the first output node 35-3 of the battery actuator controller 30, and may be configured to selectively apply the second output voltage VCC as first switch signal RLY3+ to the third (precharge) battery actuator relay 43. Further, the third low side switch 323 is interconnected between the second input node 34 and the second output node 36-3 of the battery actuator controller 30, and may be configured to selectively apply the potential of the second stack node 12 as second switch signal RLY3− to the third battery actuator relay 43.

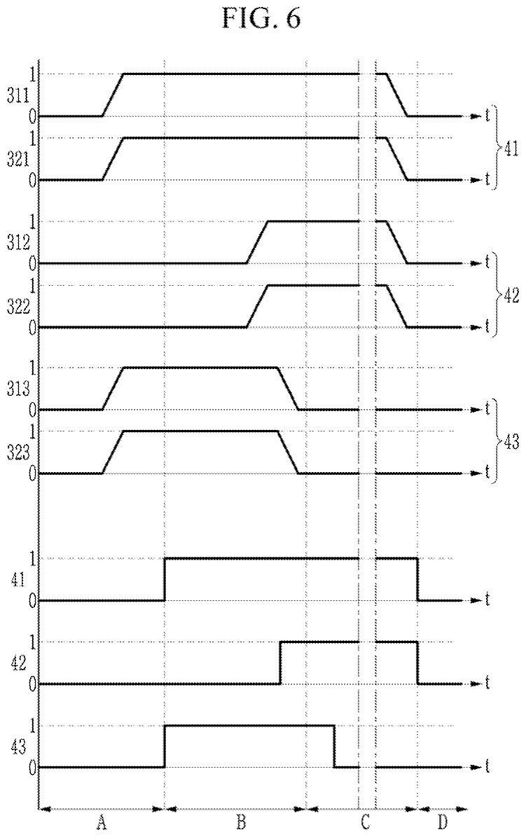

Referring to FIG. 6, a timing diagram of the high side switches 311 to 313, the low side switches 321 to 323, and the respective battery actuator relays 41 to 43 is illustrated.

The switching operations of high side switches 311 to 313 and low side switches 321 to 323, and thus the corresponding operations of the battery actuator relays 41 to 43 are controlled by the switch control circuit 37 as illustrated in FIG. 4. Further, the timing diagram of FIG. 6 illustrates four different operation phases of the battery system that are denoted with A, B, C, and D, respectively. Therein, operation phase A refers to a battery disconnected state, operation phase B refers to a pre-charging phase, operation phase C refers to a battery connected phase, and operation phase D again refers to a battery disconnected phase.

During the initial battery disconnected phase A, an operation state of the first high side switch 311, the first low side switch 321, the third high side switch 313, and the third low side switch 323 are set from an operation state “0”, i.e., non-conductive, to an operation state “1”, i.e., conductive. The transition from state “0” to “1” itself requires some time, which is represented by the sloped transition in FIG. 6. Subsequent to and in reaction to setting the high side switches 311, 313 and the low side switches 321, 323 conductive, the first battery actuator relay 41 and the third battery actuator relay 43 are set conductive.

Thereby, a transition occurs from the operation phase A to the operation phase B, i.e., to a pre-charging phase. As shown in FIG. 4, the second battery actuator relay 42 is connected in series with a precharge resistor 44 and hence a current via the second battery actuator relay 42 is limited by the precharge resistor 44. In the pre-charging phase B, a circuit capacity of a high voltage bus, e.g., of a vehicle, connected to the battery system 100 is charged. By pre-charging the circuit capacity, fusing of the actuator relays 41, 42 is avoided.

During the pre-charging phase B, the operation state of the second high side switch 312 and of the second low side switch 322 is set from an operation state “0”, i.e., non-conductive, to an operation state “1”, i.e., conductive. Again, this transition is not immediate as illustrated by the sloped transition in FIG. 6. Subsequent to and in reaction to setting the second high side switch 312 and the second low side switches 322 conductive, the second battery actuator relay 42 is set conductive. Only after the second battery actuator relay 42 is set conductive, the operation state of the third high side switch 313 and of the third low side switch 323 is set from the operation state “1”, i.e., conductive, to the operation state “0”, i.e., non-conductive. Subsequent to and in reaction to setting the third high side switch 313 and the third low side switches 323 non-conductive, the third battery actuator relay 43 is set non-conductive.

Thereby, a transition occurs from the operation phase B to the operation phase C, i.e., to a battery connected phase, wherein the battery system provides electric power to the system output nodes 101, 102 and a HV bus of a vehicle eventually connected thereto. By not setting the third battery actuator relay 43 non-conductive before the second battery actuator relay 42 is set conductive, a discharge of the circuit capacity mentioned above by a high demand load and thus fusing of the third battery actuator relay 43 may be effectively avoided. The battery connected phase C is maintained as long as power supply by battery system 100 is called for.

When power supply of battery system 100 is no longer called for, the operation state of the first high side switch 311, the second high side switch 312, the first low side switch 321 and the second low side switch 322 is set from the operation state “1”, i.e., conductive, to the operation state “0”, i.e., non-conductive. Subsequent to and in reaction to setting the high side switches 311, 312 and the low side switches 321, 322 non-conductive, the first and second battery actuator relays 41, 42 are both set non-conductive and hence the battery cell stack 15 is disconnected from the first output node 101 and from the second output node 102.

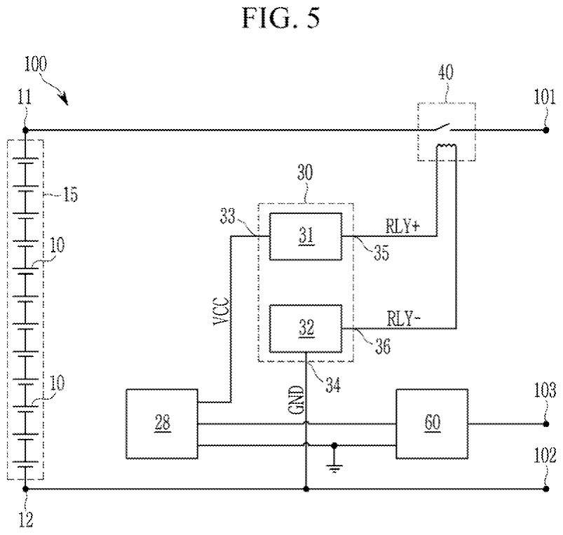

FIG. 5 illustrates a schematic circuit diagram of a battery system 100 according to another example embodiment. Therein, same elements are denoted by same reference signs as in the previously described embodiments and a repeated description is omitted.

In the battery system 100 according to the present example embodiment, a galvanically isolated DC/DC converter 28 is connected to a low voltage battery 60 and receives a battery voltage of the low voltage battery 60. Further, the galvanically isolated DC/DC converter 28 and the low voltage battery 60 are connected to a low voltage ground of the low voltage battery 60, e.g., to a chassis of an electric vehicle including the battery system 100. According to this example embodiment, the galvanically isolated DC/DC converter 28 blocks any perturbations in the high voltage domain of the battery cell stack 15 to couple into the low voltage domain of the low voltage battery 60 via the battery actuator 40.

By way of summation and review, a BMS may be coupled to the controller of one or more electrical consumers as well as to each of the battery modules of the battery system. Each battery module may include a cell supervision circuit (CSC) that may be configured to maintain the communication with the BMS and with other battery modules. The CSC may be connected to the battery cells directly or via a cell connecting unit (CCU), and may be configured to monitor cell voltages, currents and/or temperatures of some or each of the battery module's battery cells. The CSC may actively or passively balance the voltages of the individual battery cells within the module.

A battery module may further include battery actuators, such as relays, which may be disposed in an internal or external unit that may be configured to cut a connection of the battery system to an external load in case of a malfunction of the battery system. This unit may further include fuses, precharge resistors, and control electronics, and may be referred to as battery disconnect unit (BDU) or battery junction box (BJB). Each of the aforementioned control units may be realized as, or at least include, an integrated circuit (IC), a microcontroller (μC), an application specific integrated circuit (ASIC), or the like. Control units may be an integral part of the battery system and may be disposed within a common housing, or may be part of a remote control module communicating with the battery system via a suitable bus.

In an electric vehicle, an electric engine may be supplied with power by a high voltage battery system, e.g., a 48 V battery system. The 48 V battery system may be connected to a 48 V board net and may be charged by an electric generator, e.g., a combined starter-generator. The electric vehicle may further include a 12 V board net, which may be used to power at least some of the aforementioned control units, at least the battery disconnect unit or battery junction box.

A BDU or BJB may include a plurality of battery actuators, and the supply of all the battery actuators by the 12 V battery may lead to situations where a supply voltage is insufficient to maintain a non-conducting state for all the battery actuators. Further, if relays open unintendedly, an overcurrent may lead to destruction of battery actuators. Further, AC-attenuation of battery actuators is typically very low, and hence cross-talk between the HV lines and the electric lines of a LV control circuitry may occur. Coupling constants of coupling paths from a HV side to a LV side usually exceed those from a LV side to a HV side, and hence control operations of the battery actuator may be negatively interfered by signals on the HV lines of the battery system. Particularly in a malfunctioning battery system, unusual signals may be generated on the HV side, increasing a risk in the LV control lines in situations where a reliable control is important.

As described above, embodiments relate to a battery system that may provide improve control of battery actuators, and with reduced cross-talk to a low voltage side of the battery actuators.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present example embodiment as set forth in the following claims.

### REFERENCE SIGNS

10 battery cell

11 first stack node

12 second stack node

15 battery cell stack

20 DC/DC converter

21 first switch

22 second switch

23 inductance

25 converter node

26 converter output node

27 converter input node

28 galvanically isolated DC/DC converter

30 battery actuator controller

31 high side driver

32 low side driver

33 first input node

34 second input node

35 first output node

36 second output node

37 switch control circuit

40 battery actuator

41 first main relay

42 second main relay

43 precharge relay

44 precharge resistor

50 battery system controller

100 battery system

101 first output node

102 second output node

103 low voltage node

311 first high side switch

312 second high side switch

313 third high side switch

321 first low side switch

322 second low side switch

323 third low side switch

What is claimed is:

1. A battery system, comprising:
a battery cell stack including battery cells connected between a first stack node and a second stack node, the battery cell stack being configured to supply a stack voltage to a first battery system output node that is connected to the first stack node;
a DC/DC converter configured to receive a first output voltage of the battery cell stack, and to down-convert the first output voltage to a second output voltage;
a battery actuator interconnected between the battery cell stack and one of the first battery system output node and a second battery system output node, and configured to be controlled to be set either conductive or non-conductive; and
a controller configured to control the battery actuator, the controller including a first input node receiving the second output voltage and a second input node connected to the second stack node, the controller being configured to output, to the battery actuator, a first switch signal via a first controller output node and a second switch signal via a second controller output node.

2. The battery system as claimed in claim 1, further comprising a low voltage battery that is charged by the second output voltage.

3. The battery system as claimed in claim 1, wherein the first output voltage is supplied by less than all of the battery cells of the battery cell stack.

4. The battery system as claimed in claim 1, wherein the DC/DC converter is one of a buck converter, a buck-boost-converter, a low-dropout regulator, a flyback converter, a forward converter, and a push-pull-converter.

5. The battery system as claimed in claim 1, wherein the DC/DC converter includes:
a first switch and an inductance connected in series between a converter input node and a converter output node,
a converter node in between the first switch and the inductance, and
a second switch connected between the second stack node and the converter node.

6. A battery system, comprising:
a battery cell stack including battery cells connected between a first stack node and a second stack node, and configured to supply a stack voltage to a first battery system output node that is connected to the first stack node;
a low voltage battery configured to supply a battery voltage;
a galvanically isolated DC/DC converter configured to receive the battery voltage, and to convert the battery voltage to a second output voltage;
a battery actuator interconnected between the battery cell stack and one of the first battery system output node and a second battery system output node, and configured to be controlled to be set either conductive or non-conductive; and
a controller configured to control the battery actuator, the controller including a first input node receiving the second output voltage, and a second input node connected to the second stack node, wherein the controller is configured to output, to the battery actuator, a first switch signal via a first controller output node and a second switch signal via a second controller output node.

7. The battery system as claimed in claim 6, wherein:
the first switch signal is at a same voltage level as the second output voltage, and/or
the second switch signal is at a same voltage level as the second stack node.

8. The battery system as claimed in claim 6, wherein the controller includes:
a high side driver interconnected between the first input node and the first controller output node, and
a low side driver interconnected between the second input node and the second controller output node.

9. The battery system as claimed in claim 6, wherein the second stack node is at a ground voltage potential of the battery system.

10. The battery system as claimed in claim 6, wherein the battery actuator is a first battery actuator, and is interconnected between the first stack node and the first battery system output node; and
the battery system further comprises a second battery actuator interconnected between the second stack node and the second battery system output node,
wherein each of the first battery actuator and the second battery actuator is connected to the first controller output node and to the second controller output node.

11. The battery system as claimed in claim 10, further comprising a precharge battery actuator connected in series with a precharge resistor, wherein:
the precharge battery actuator and the precharge resistor are commonly connected in parallel to the second battery actuator, and
the precharge battery actuator is connected to the first controller output node and to the second controller output node.

12. The battery system as claimed in claim 8, wherein:
the high side driver includes a plurality of high side switches, each of the high side switches being interconnected between the first input node and one of a plurality of battery actuators, and
the low side driver includes a plurality of low side switches, each of the low side switches being interconnected between the second input node and one of the plurality of battery actuators.

13. The battery system as claimed in claim 12, further comprising a switch control circuit configured to individually control a conductivity state of each of the high side switches and each of the low side switches.

14. The battery system as claimed in claim 6, wherein the battery actuator is one of a contactor and a relay.

15. A battery system controller, comprising:
a DC/DC converter configured to receive a first output voltage of a battery cell stack, and to down-convert the first output voltage to a second output voltage; and
a battery actuator controller that includes a first input node that receives the second output voltage, and a second input node that is connected to a second stack node of the battery cell stack,
wherein the battery actuator controller is configured control a battery actuator and to output, to the battery actuator, a first switch signal via a first controller output node and a second switch signal via a second controller output node.

16. The battery system as claimed in claim 1, wherein:
the first switch signal is at a same voltage level as the second output voltage, and/or
the second switch signal is at a same voltage level as the second stack node.

17. The battery system as claimed in claim 1, wherein the controller includes:
a high side driver interconnected between the first input node and the first controller output node, and
a low side driver interconnected between the second input node and the second controller output node.

18. The battery system as claimed in claim 1, wherein the second stack node is at a ground voltage potential of the battery system.

19. The battery system as claimed in claim 17,
wherein the high side driver includes a plurality of high side switches, each of the high side switches being interconnected between the first input node and one of a plurality of battery actuators, and
wherein the low side driver includes a plurality of low side switches, each of the low side switches being interconnected between the second input node and one of the plurality of battery actuators.

20. The battery system as claimed in claim 1, wherein the battery actuator is one of a contactor and a relay.
